(19) United States
(12) Patent Application Publication
(10) Pub. No.: US 2026/0006276 A1
(43) Pub. Date: Jan. 1, 2026

(54) DYNAMIC RENDERING OF A CONTEXTUALIZED ADVERTISEMENT

(71) Applicant: Roku, Inc., San Jose, CA (US)

(72) Inventors: Mehul Sanghavi, San Jose, CA (US); Phi Thuan Au, Austin, TX (US); Chul Ho Jang, San Jose, CA (US); Hasher Hamza, New York, NY (US)

(21) Appl. No.: 18/755,484

(22) Filed: Jun. 26, 2024

(51) Int. Cl. H04N 21/2668; H04N 21/431; H04N 21/45; H04N 21/482; H04N 21/81

(52) U.S. Cl. CPC H04N 21/2668; H04N 21/4316; H04N 21/4532; H04N 21/482; H04N 21/812

(57) ABSTRACT

Aspects of the disclosed technology provide solutions for dynamically rendering a contextualized advertisement based on understanding of user data on a user interface. An example method can include displaying a collection of selectable channel tiles on a first portion of a display. Each selectable channel tile represents a channel for streaming media content. The example method includes receiving a user input on a target channel tile among the collection of selectable channel tiles. The target channel tile corresponds to a target channel. The example method further includes accessing a user profile that is associated with the user input and generating, based on at least one of the user profile or one or more attributes associated with the target channel, a contextualized advertisement of one or more media content items provided by the target channel.

### BACKGROUND

### Field

This disclosure is generally directed to multimedia systems, and more particularly to dynamically rendering a contextualized advertisement based on understanding of user data.

### SUMMARY

Provided herein are system, apparatus, article of manufacture, method and/or computer program product embodiments, and/or combinations and sub-combinations thereof, for dynamically rendering a contextualized advertisement on a display based on understanding of user data.

In some aspects, a method is provided for dynamically rendering a contextualized advertisement on a display (e.g., graphical user interface) based on user data, media content, and/or content provider. The method may be implemented by media system(s) or content server(s) used to provide video content/media content to remote devices and/or by a media device(s) communicatively coupled to, for example, a display device. The method can operate in other devices such as, for example and without limitation, a smart television, computer, or a mobile device, among others.

The method can operate by displaying a collection of selectable channel tiles on a first portion of a display. Each selectable channel tile represents a channel for streaming media content. The method can include receiving a user input on a target channel tile among the collection of selectable channel tiles. The target channel tile corresponding to a target channel. The method also can include accessing a user profile that is associated with the user input. Based on at least one of the user profile or one or more attributes associated with the target channel, a contextualized advertisement of one or more media content items provided by the target channel can be generated.

In some aspects, a system is provided for dynamically rendering a contextualized advertisement based on understanding of user data. The system can include one or more memories and at least one processor coupled to at least one of the one or more memories and configured to display a collection of selectable channel tiles on a first portion of a display. Each selectable channel tile represents a channel for streaming media content. The at least one processor of the system can be configured to receive a user input on a target channel tile among the collection of selectable channel tiles. The target channel tile corresponding to a target channel. The at least one processor of the system can also be configured to access a user profile that is associated with the user input. Based on at least one of the user profile or one or more attributes associated with the target channel, a contextualized advertisement of one or more media content items provided by the target channel can be generated.

In some aspects, a non-transitory computer-readable medium is provided for dynamically rendering a contextualized advertisement based on understanding of user data. The non-transitory computer-readable medium can have instructions stored thereon that, when executed by at least one computing device, cause the at least one computing device to display a collection of selectable channel tiles on a first portion of a display. Each selectable channel tile represents a channel for streaming media content. The instructions of the non-transitory computer-readable medium can, when executed by the at least one computing device, cause the at least one computing device to receive a user input on a target channel tile among the collection of selectable channel tiles. The target channel tile corresponding to a target channel. The instructions of the non-transitory computer-readable medium can, when executed by the at least one computing device, also cause the at least one computing device to access a user profile that is associated with the user input. Based on at least one of the user profile or one or more attributes associated with the target channel, the instructions of the non-transitory computer-readable medium can, when executed by the at least one computing device, cause the at least one computing device to generate a contextualized advertisement of one or more media content items provided by the target channel.

### BRIEF DESCRIPTION OF THE FIGURES

The accompanying drawings are incorporated herein and form a part of the specification.

FIG. 1 illustrates a block diagram of an example multimedia environment, according to some examples of the present disclosure.

FIG. 2 illustrates a block diagram of an example streaming media device, according to some examples of the present disclosure.

FIG. 3 illustrates an example system for dynamically rendering a contextualized advertisement, according to some examples of the present disclosure.

FIGS. 4A and 4B illustrate an example graphical user interface for dynamic rendering of a contextualized advertisement, according to some examples of the present disclosure.

FIG. 5 illustrates another example graphical user interface for dynamic rendering of a contextualized advertisement, according to some examples of the present disclosure.

FIG. 6 illustrates a flowchart of an example method for dynamically rendering a contextualized advertisement on a display based on user data, according to some examples of the present disclosure.

FIG. 7 illustrates a flowchart of an example method for determining contextual, spatial, and temporal attributes of an advertisement for a target channel, according to some examples of the present disclosure.

FIG. 8 illustrates a flowchart of an example method for dynamically rendering a contextualized advertisement of a live media content, according to some examples of the present disclosure.

FIG. 9 is a diagram illustrating an example of a neural network architecture, according to some examples of the present disclosure.

FIG. 10 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Users access and consume media content such as videos, at any time of day or any location, using a wide variety of client devices such as, for example, and without limitations, smart phones, desktop computers, laptop computers, tablet computers, televisions (TVs), IPTV receivers, media devices, monitors, projectors, smart wearable devices, appliances, and Internet-of-Things (IoT) devices, among others. The media content may be accessible on various platforms across diverse channels by a wide range of viewers. Many channels use advertisements to promote media content that is or is to be available for streaming on the channel to attract viewers. However, a lack of user context in advertisements leads to users who are unlikely to be interested or receptive, and therefore, irrelevant advertisement is more likely to be ignored or viewed negatively by users.

Aspects of the disclosed technology provide solutions for dynamically rendering a contextualized advertisement on a display based on understanding of user data (e.g., information derived from user profile). In some aspects, a media system (e.g., a user interface system) can display a collection of selectable channel tiles on a first portion of a display. For example, a grid of channel tiles can be displayed on a first portion of a display (e.g., a graphical user interface (GUI)) where each of the channel tiles represents a channel for streaming media content. Upon receiving a user input on one of the channel tiles, a contextualized advertisement for a media content item, which is provided by the respective channel can be presented on a second portion of the display. For example, the contextualized advertisement can be generated based on understanding of user profile (e.g., user data), a target channel (e.g., content provider), and/or media content. As such, an advertisement can be delivered to the right audience/viewer, and draw user's attention in a personalized way, thereby leading to improved user experience (eg., advertisement experience) and user engagement with the channel.

In some aspects, a system (e.g., a media system or a user interface system) can determine temporal, spatial, and/or contextual attributes of an advertisement based on the analysis of user profile (e.g., user data), a target channel, and/or media content. For example, the system can determine the timing or duration of the advertisement (e.g., when to display the advertisement, when to end displaying the advertisement, when to switch to a different advertisement, etc.). Also, the system can determine the physical or geographic placement or size of the advertisement in which it is presented on a display of a user device (e.g., GUI). The system can also determine the context of an advertisement (e.g., a type, a genre, a character, etc.) based on a relevance to a viewer.

In some implementations, machine learning techniques can be used to analyze user profile and/or channel(s) and determine a customized/personalized advertisement for media content item that is targeted for a viewer. For example, machine learning techniques can be used to determine, collectively and simultaneously, various dimensions (e.g., temporal, spatial, and contextual dimensions) of an advertisement that promotes a media content item, which is available for streaming at a target channel.

As discussed in further detail below, the technologies and techniques described herein can significantly improve user experience by providing solutions for dynamically rendering a contextualized advertisement based on understanding of user data, a content provider (e.g., a channel), and/or media content. Furthermore, a personalized advertisement, which is user-specific, channel-specific, and content-specific, can improve user experience (e.g., advertisement experience) and further, improve user engagement and user conversion with the target channel (e.g., higher propensity or conversion to select and watch the target channel).

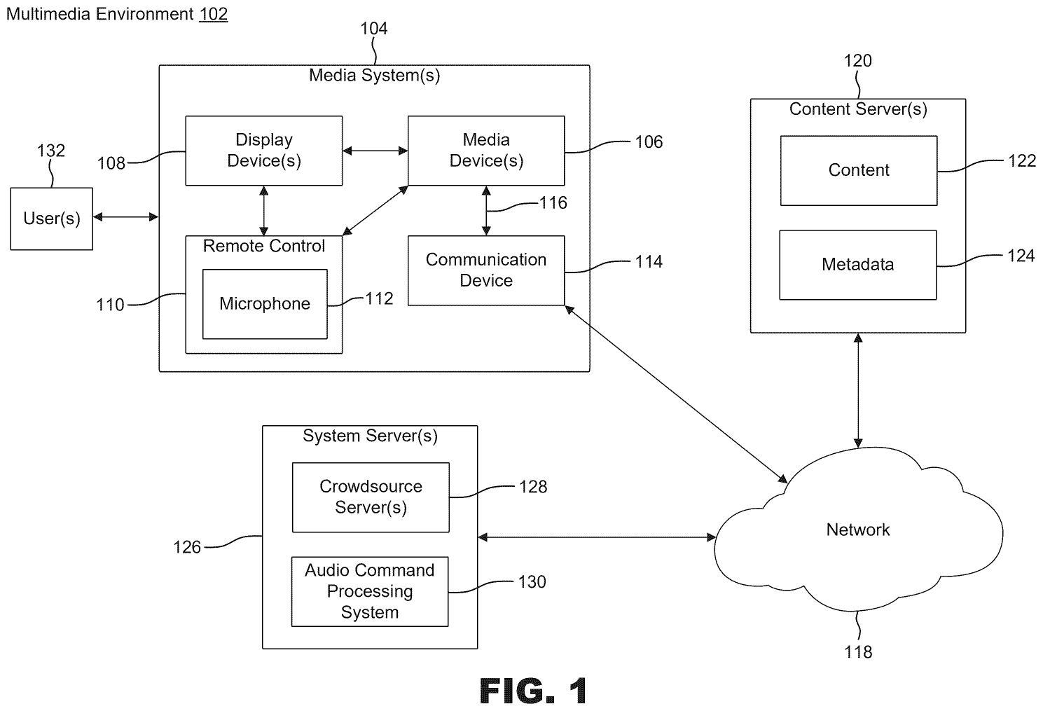

Various embodiments and aspects of this disclosure may be implemented using and/or may be part of a multimedia environment 102 shown in FIG. 1. It is noted, however, that multimedia environment 102 is provided solely for illustrative purposes and is not limiting. Examples and embodiments of this disclosure may be implemented using, and/or may be part of, environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some examples, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

In various examples, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In some examples, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources 120). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, targeted media content, software, and/or any other content or data objects in electronic form.

The metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media systems 104. Accordingly, the media devices 106 may lend themselves to crowdsourcing embodiments and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 128 may operate to cause closed captioning to be automatically turned on and/or off during future streamings of the movie.

The system servers 126 may also include an audio command processing system 130. As noted above, the remote control 110 may include a microphone 112. The microphone 112 may receive audio data from users 132 (as well as other sources, such as the display device 108). In some examples, the media device 106 may be audio responsive, and the audio data may represent verbal commands from the user 132 to control the media device 106 as well as other components in the media system 104, such as the display device 108.

In some examples, the audio data received by the microphone 112 in the remote control 110 is transferred to the media device 106, which is then forwarded to the audio command processing system 130 in the system servers 126. The audio command processing system 130 may operate to process and analyze the received audio data to recognize the user 132's verbal command. The audio command processing system 130 may then forward the verbal command back to the media device 106 for processing.

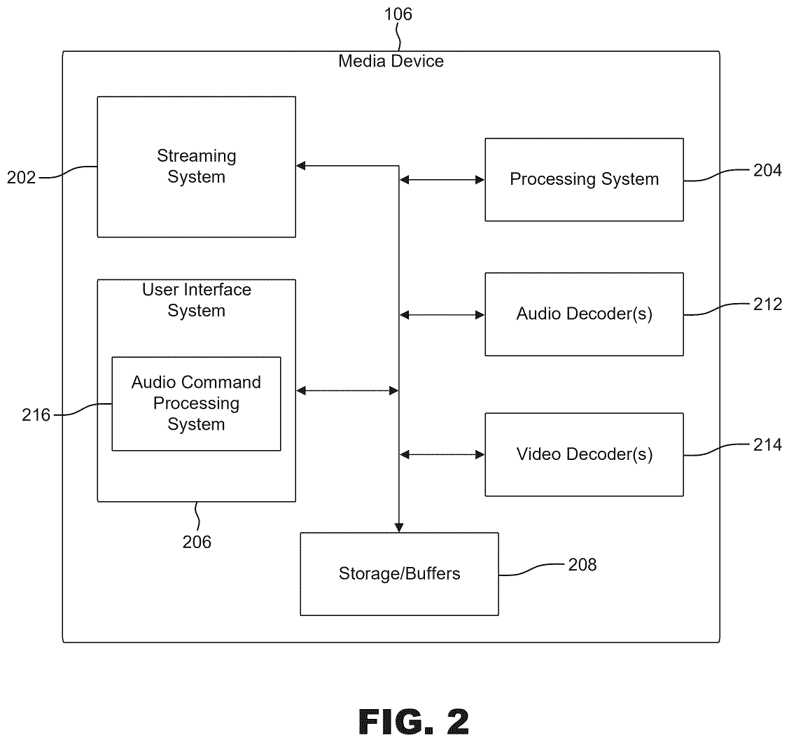

In some examples, the audio data may be alternatively or additionally processed and analyzed by an audio command processing system 216 in the media device 106 (see FIG. 2). The media device 106 and the system servers 126 may then cooperate to pick one of the verbal commands to process (either the verbal command recognized by the audio command processing system 130 in the system servers 126, or the verbal command recognized by the audio command processing system 216 in the media device 106).

FIG. 2 illustrates a block diagram of an example media device 106, according to some embodiments. Media device 106 may include a streaming system 202, processing system 204, storage/buffers 208, and user interface module 206. As described above, the user interface module 206 may include the audio command processing system 216.

The media device 106 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, VVC, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, VVC, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some examples, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming system 202 of the media device 106 may request the selected content from the content server(s) 120 over the network 118. The content server(s) 120 may transmit the requested content to the streaming system 202. The media device 106 may transmit the received content to the display device 108 for playback to the user 132.

In streaming examples, the streaming system 202 may transmit the content to the display device 108 in real time or near real time as it receives such content from the content server(s) 120. In non-streaming examples, the media device 106 may store the content received from content server(s) 120 in storage/buffers 208 for later playback on display device 108.

### Dynamic Rendering of a Contextualized Advertisement

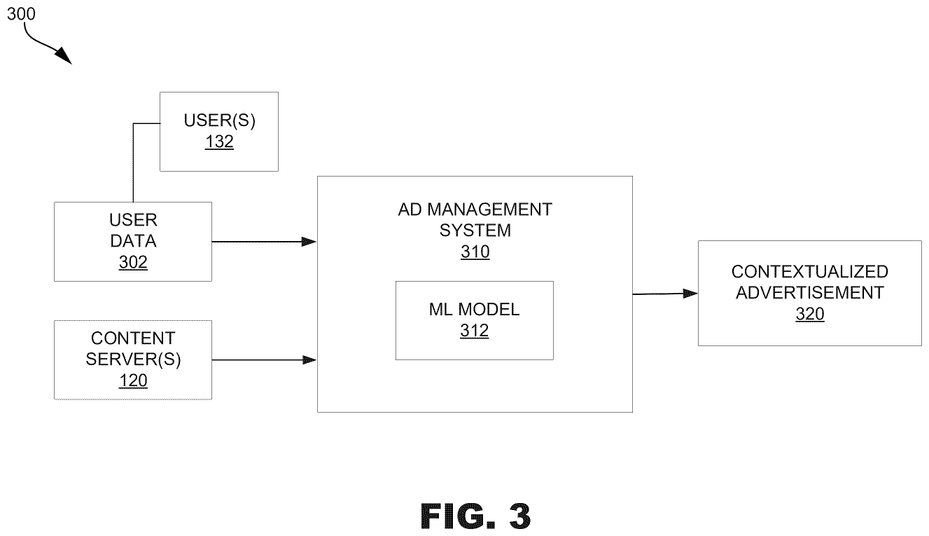

FIG. 3 illustrates an example system 300 for dynamically rendering a contextualized advertisement. The system 300 includes an advertisement (AD) management system 310, which is configured to generate a contextualized advertisement 320 based on user data 302 associated with user 132 and/or content data from content server(s) 120. The various components of system 300 can be implemented at applicable places in the multimedia environment 102 shown in FIG. 1. In some examples, AD management system 310 can be implemented as part of a server (e.g., content server(s) 120 and/or system server(s) 126), as part of a media device (e.g., media device(s) 106), and/or as part of cloud computing resources that may be associated with a network (e.g., network 118). For example, AD management system 310 can be a software algorithm running on content server(s) 120. In other words, AD management system 310 can be separate from content server(s) 120 or media device 106.

The AD management system 310 is configured to perform applicable functions related to analyzing user data 302, content 122, and/or metadata 124 to identify one or more attributes of a contextualized advertisement 320 to be displayed on display device 108 for user 132. For example, AD management system 310 can access user data 302 (e.g., user profile or user profile information) associated with user 132. The user data 302 can include, for example and without limitation, user demographics (e.g., age, sex, geographic location, income, generation, occupation, etc.), user preferences (e.g., genre, casts, length of content, etc.), a geographic location, privacy settings, viewing history or viewing patterns, user engagement with a target channel, social media activities, and so on.

As previously described, multimedia environment 102 may include a plurality of content servers 120 (also called content providers, channels, or sources). For example, each of the plurality of content servers 120 can correspond to a channel that streams music, movies, TV shows, live events (e.g., sports events, live news broadcasts, etc.), fitness content, and so on. Each content server 120 stores content 122, which includes any combination of music, videos, movies, TV programs, multimedia, images still pictures, text, graphics, software, and/or any other content or data objects in electronic form. Such content 122 and metadata 124 can be accessed by AD management system 310.

Based on the user data 302 and/or content 122 and metadata 124 from the plurality of content servers 120, AD management system 310 can generate contextualized advertisement 320, which may be channel-specific, content-specific, and/or user-specific. For example, upon receiving a user input with respect to one of the channels (i.e., a target channel), AD management system 310 can generate contextualized advertisement 320 based on data accessed from the respective content server 120 and user data 302. By way of example, AD management system 310 can generate contextualized advertisement 320, which depicts, describes, or promotes content 122 (e.g., music, movie, TV shows, etc.) that is available for streaming on the target channel and meets user preferences of user 132.

The AD management system 310 can determine a type or format of contextualized advertisement 320, for example, a still image of content 122, an animation, a portion of teaser or trailer, whether to include text or closed-caption (and if included, the size of texts), whether to include audio in contextualized advertisement 320, and so on.

In some aspects, contextualized advertisement 320 can be associated with a product or services that may be associated with the target channel. For example, contextualized advertisement 320 includes advertisement that promotes various subscription options of the target channel such that user 132 may choose one of the subscription options to watch the content 122 provided by the target channel.

In some implementations, AD management system 310 can use an algorithm, such as a machine learning algorithm, to analyze user data 302 and/or content 122 and metadata 124 from the plurality of content servers 120. For example, AD management system 310 may include an applicable machine learning-based technique or neural network (e.g., ML model 312), which is configured to determine various dimensions (e.g., temporal, spatial, and contextual dimensions) of an advertisement to generate contextualized advertisement 320 as an output. As such, AD management system 310 can, using ML model 312, generate a customized/personalized advertisement that is tailored to a particular user 132 and a target channel. Non-limiting examples of the ML model (e.g., neural network) can include a convolutional neural network (CNN), hidden Markov models, Recurrent Neural Network (RNN), deep learning, and Generative Adversarial Network (GAN), among others.

In some aspects, contextualized advertisement 320 can be displayed, played, or presented on a user device (e.g., display device 108). For example, media device 106 may include a streaming device (e.g., Over-the-top (OTT) device or box) that provides OTT media services (e.g., connecting to various OTT online platforms) and is coupled to display device 108 such that media device 106 sends content 122 straight to display device 108. In some examples, media device 106 can be connected to the plurality of content servers 120, via network 118, and receive content 122 from various content providers. The display device 108 can, when initially launched, display a group of buttons, tiles, or blocks for the multiple content providers (e.g., channels) that user 132 can select from.

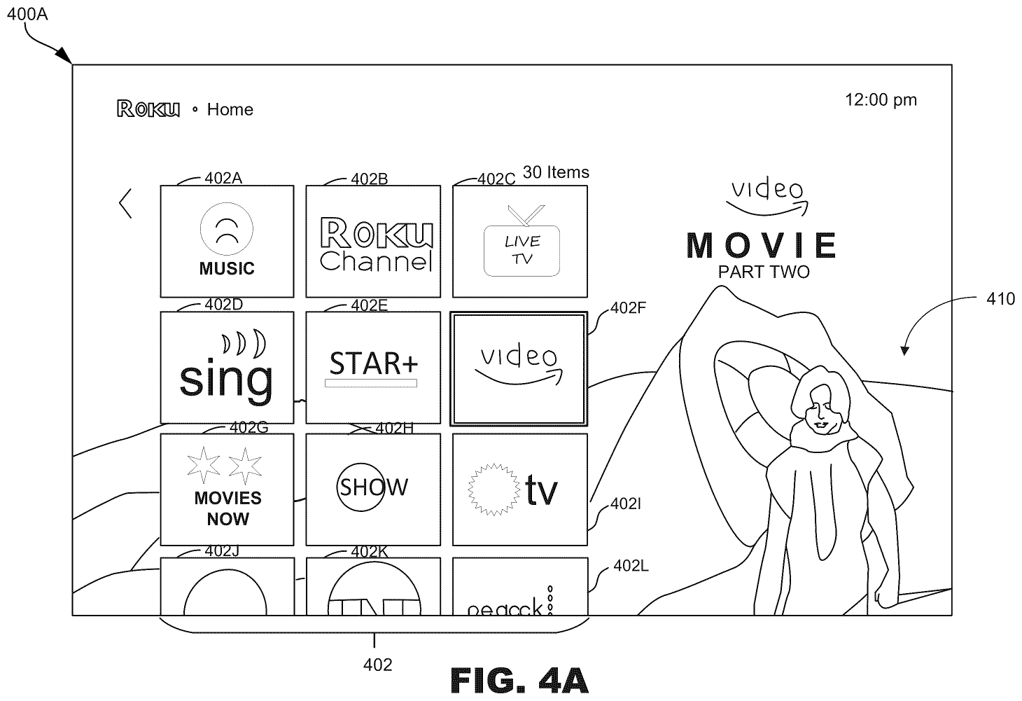

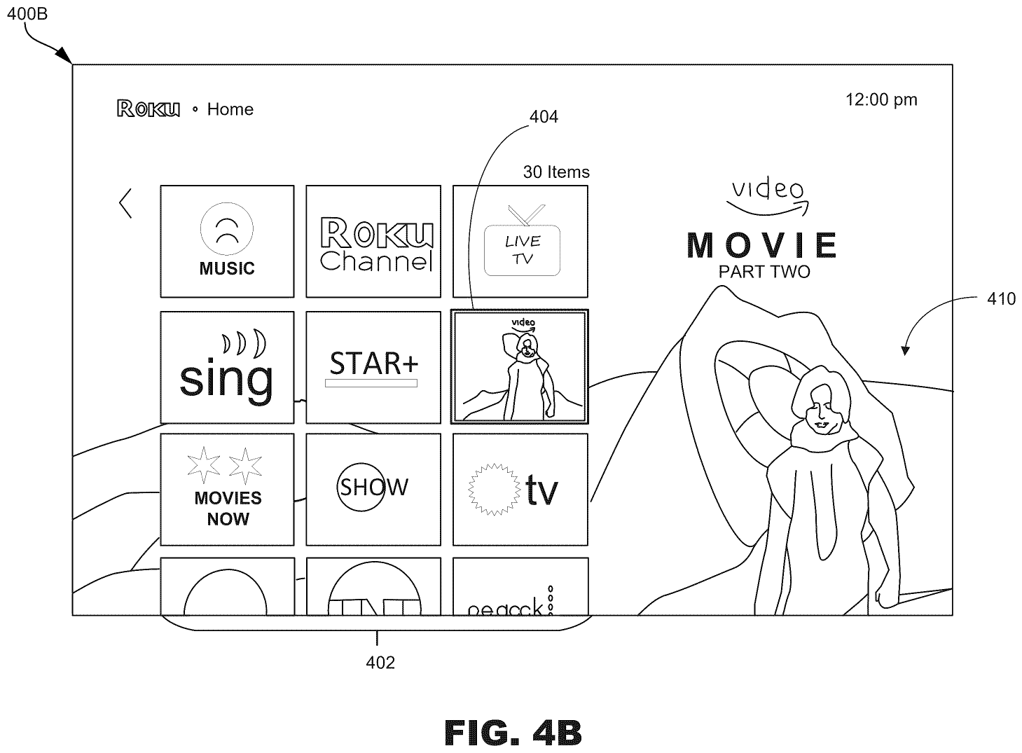

FIG. 4A is an example graphical user interface (GUI) 400A for dynamic rendering of a contextualized advertisement. In some aspects, GUI 400A can be displayed on display device 108, which is configured to play content 122. As shown, GUI 400A includes a grid 402 of selectable channel tiles 402A-L. Each channel tile 402A-L corresponds to a content channel (e.g., content provider or source) that provides streaming services (e.g., music, movies, TV shows, live events, and so on.). For example, user 132 can hover a user-controlled pointer over the grid 402 of channel tiles 402A-L to select a channel for playing a media content. If GUI 400A is a touch-sensitive display, user 132 can use a gesture (e.g., pointing, clicking, scrolling, swiping, etc.) to navigate GUI 400A and select a channel to play a media content.

Upon receiving a user input on one of the selectable channel tiles 402A-L, for example, a target channel tile 402F corresponding to a target channel, a contextualized advertisement 410 can be displayed in the background of GUI 400A, as shown in FIG. 4A. The contextualized advertisement 410 can include an advertisement promoting media content that is available for streaming on the target channel. For example, AD management system 310 can analyze content 122 and/or metadata 124 from content server 120, which corresponds to the target channel. Further, AD management system 310 can access and analyze user data 302 associated with user 132 who has provided the user input on target channel tile 402F corresponding to the target channel. As follows, AD management system 310 can generate contextualized advertisement 410 based on content 122 and/or metadata 124 associated with the target channel and user data 302. For example, contextualized advertisement 410 can be a movie poster or a portion of a movie trailer for a movie that is or is to be available on the target channel. Also, contextualized advertisement 410 can include a character or an actor from content 122 that has an affinity to user 132 or is in media content that user 132 has previously watched.

FIG. 4B illustrates another example GUI 400B for dynamic rendering of a contextualized advertisement. The example GUI 400B includes a grid 402 of multiple channel tiles. Similar to FIG. 4A, upon receiving a user input on a target tile 404, a contextualized advertisement 410 can be displayed in the background of GUI 400B. In some implementations, GUI 400B can include target tile 404 overlaid with a resized image of contextualized advertisement 410 as shown in FIG. 4B. For example, AD management system 310 can generate an image of a contextualized advertisement in the size that can be overlaid onto target tile 404.

In some examples, target tile 404 overlaid with a contextualized advertisement can be displayed when GUI 400B is initially launched such that user 132 can see the advertisement without a user input on target tile 404. In other examples, the image of contextualized advertisement can be displayed or overlaid onto target tile 404 upon receiving a user input on target tile 404. For example, when user 132 hovers a pointer over target tile 404, the image of contextualized advertisement can be displayed on target tile 404.

In some implementations, AD management system 310 can generate a contextualized advertisement that can be overlaid onto target tile 404, independently from the contextualized advertisement 410. For example, a contextualized advertisement for target tile 404 can be generated using its own set of targeting tactics or parameters that may be different than what may be used for generating contextualized advertisement 410. In some examples, a contextualized advertisement for target tile 404 can be based on or focus on a cast and/or character that user 132 may have an affinity to. In some examples, AD management system 310 can use stills (e.g., a screenshot) from the target program (i.e., media content that the advertisement is promoting) that is popular with other users or can form an identity with user 132. For example, AD management system 310 can use crowd-sourced favorites for the target program or stills that have resonated with other users. In another example, AD management system 310 can use stills that may include user's neighborhood or city in the target program.

In some aspects, AD management system 310 can apply an animated effect on the contextualized advertisement overlaid onto target tile 404. For example, the contextualized advertisement on target tile 404 can be morphed or transitioned into contextualized advertisement 410, for example, upon receiving user's input on target tile 404, when user 132 hovers target tile 404 for over a predetermined time threshold, or after giving user 132 a visual cue of the upcoming changes. In another example, the contextualized advertisement on target tile 404 can be a jigsaw puzzle piece that reveals the entire screen with a full-screen canvas (e.g., stills from the target program) around it. The transition from one jigsaw puzzle piece into the full screen can be executed upon receiving user's input on target tile 404, when user 132 hovers target tile 404 for over a predetermined time threshold, or after giving user 132 a visual cue of the upcoming change.

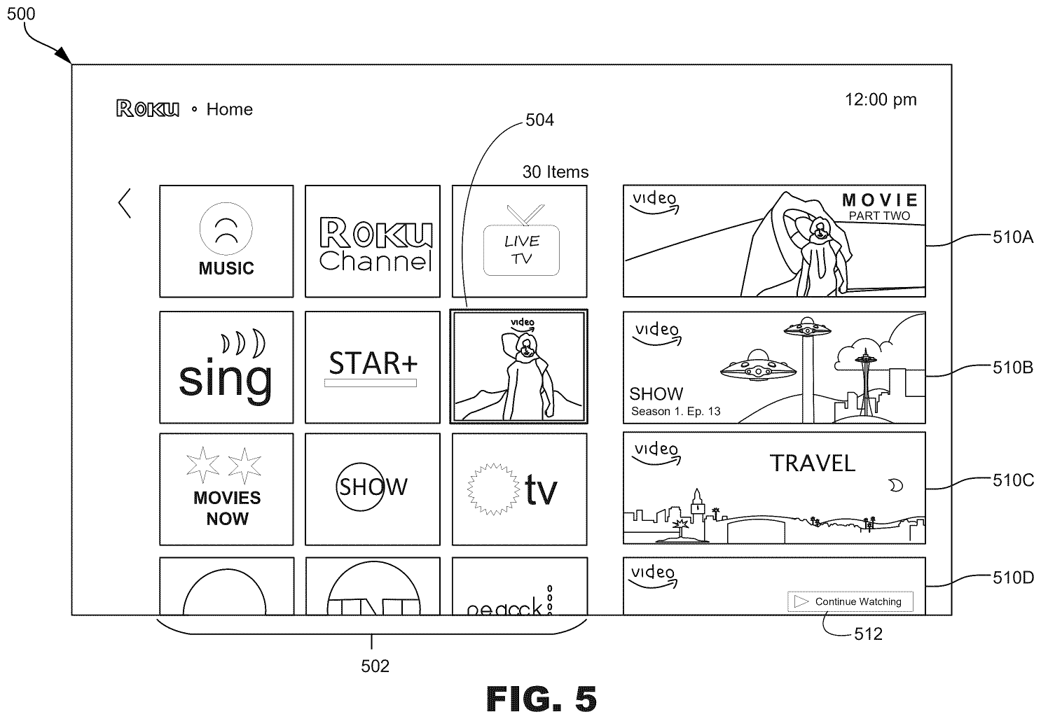

FIG. 5 illustrates another example GUI 500 for dynamic rendering a contextualized advertisement. The example GUI 500 includes a grid 502 of multiple channel tiles where each of channel tile corresponds to a channel for streaming media content. When user 132 hovers over a target tile 504 corresponding to a target channel, a list of contextualized advertisements 510A, 510B, 510C, 510D can be displayed. For example, upon receiving a user input on target tile 504, AD management system 310 can access and analyze content 122 and/or metadata 124 from content server 120, which corresponds to the target channel. Further, AD management system 310 can access and analyze user data 302 associated with user 132 who has provided the user input on target tile 504 corresponding to the target channel. As follows, AD management system 310 can generate a list of contextualized advertisements 510A-D based on content 122 and/or metadata 124 associated with the target channel and user data 302 where the list of contextualized advertisements 510A-D is channel-specific and user-specific and therefore improves the user experience (e.g., user engagement and user conversion).

In some examples, the list of contextualized advertisements 510A-D can include an advertisement of media content that user 132 was watching and has not finished. For example, contextualized advertisement 510D can include the last scene of media content that user 132 was previously watching and a “continue to watch” button 512, which may direct user 132, when selected, to play the media content on the target channel.

In some implementations, AD management system 310 can rank or order multiple contextualized advertisements 510A-D based on user data 302 and/or content data from content servers 120. For example, AD management system 310 can assign a score, value, grade, or confidence level for each content by assessing various attributes derived from user data 302, content 122, and/or metadata 124 and display the contextualized advertisements 510A-D based on the score, value, grade, or confidence level (e.g., from the highest score to the lowest score). For example, contextualized advertisement 510A may have a higher confidence level for user conversion than contextualized advertisement 510D.

In some aspects, AD management system 310 can render the target tile 504 in an ‘ad pod’ or a carousel of ad tiles. For example, if user 132 continues to keep the focus on target tile 504, then another image of contextualized advertisement can be shown on the target tile 504. The second image of contextualized advertisement can be associated with a different media content than the initial contextualized advertisement on target tile 504. In some implementations, AD management system 310 can map a different set or list of contextualized advertisements when the contextualized advertisement on target tile 504 changes. For example, if the user's dwell time on target tile 504 exceeds a predetermined time threshold (e.g., 5 seconds, 10 seconds, 30 seconds, etc.), AD management system 310 can load another contextualized advertisement on target tile 504 and map a new set of banners and contextualized advertisements by replacing contextualized advertisements 510A-D. As follows, a channel partner (e.g., content provider) can capture the user's attention and provide the user with a glimpse of a variety of media content with a single focus on its tile.

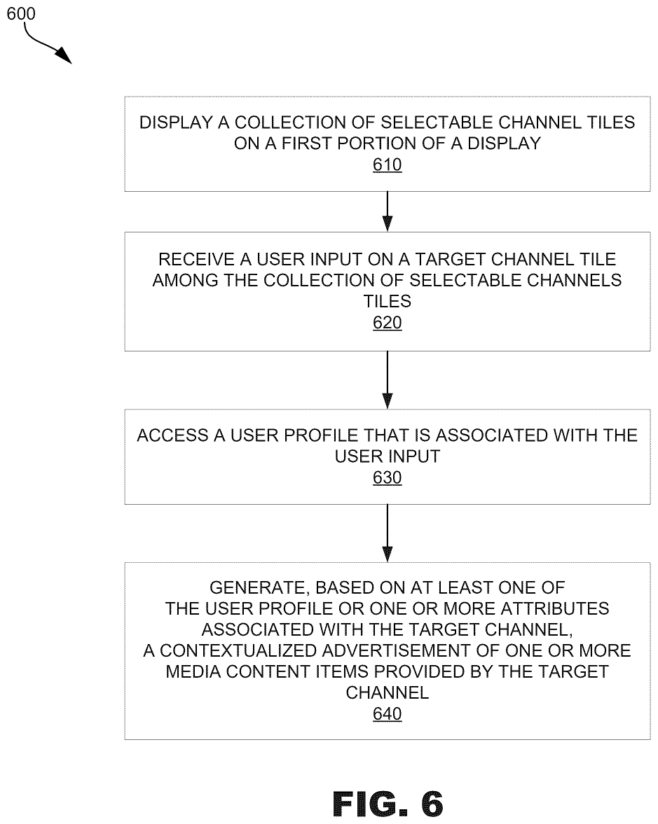

FIG. 6 illustrates a flowchart of an example method 600 for dynamically rendering a contextualized advertisement on a display based on user data, according to some examples of the present disclosure. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art. Method 600 shall be described with reference to FIGS. 3 and 4A. However, method 600 is not limited to that example.

In step 610, method 600 includes displaying a collection of selectable channel tiles on a first portion of a display. Each selectable channel tile represents a channel for streamlining media content. For example, AD management system 310 may display a collection (e.g., grid 402) of selectable channel tiles 402A-L on a first portion of a display (e.g., GUI 402A, 402B, 500). Each selectable channel tile 402A-L can correspond to a channel for streaming media content (e.g., music, movies, TV shows, live events, and so on.).

In step 620, method 600 includes receiving a user input on a target channel tile among the collection of selectable channel tiles. The target channel tile corresponds to a target channel. For example, AD management system 310 may receive a user input on a target channel tile 402F among the collection of selectable channel tiles 402A-L on GUI 400A. The target channel tile 402F corresponds to a target channel that broadcasts or streams content 122.

In step 630, method 600 includes accessing a user profile that is associated with the user input. For example, AD management system 310 can access user data 302 (e.g., user profile, user profile information, etc.) that is associated with the user input (e.g., user input from user 132). The user data 302 may include any information associated with user 132 or viewer. For example, the user data 302 can provide any information associated with user(s) 132 or viewer who has provided the user input. Non-limiting examples of user data 302 can include user demographics (e.g., age, sex, geographic location, income, generation, occupation, etc.), user preferences (e.g., genre, casts, length of content, etc.), a geographic location, privacy settings, viewing history or viewing patterns, social media activities, user engagement with a target channel, and so on.

In step 640, method 600 includes generating, based on at least one of the user profile or one or more attributes associated with the target channel, a contextualized advertisement of one or more media content items provided by the target channel. For example, AD management system 310 can generate a contextualized advertisement 320, 410 of one or more media content items provided by the target channel based on at least one of user data 302 or one or more attributes associated with the target channel.

In some aspects, the one or more attributes associated with the target channel can be derived from data that is accessible from content servers 120 (e.g., content 122, metadata 124, etc.). Non-limiting examples of the attributes associated with the target channel can include subscription options, a plurality of media contents that are available for streaming on the target channel, popularity of the plurality of media contents, or feedback from views on the plurality of media contents. In some examples, metadata 124 can include information associated with a media content studio that produces or distributes the media content items (e.g., content 122) that are provided by the respective channel or content server 120.

Further, the contextualized advertisement can be generated using a machine learning model. For example, AD management system 310 can include ML model 312, which can collectively analyze user data 302 and content 122 and/or metadata 124 from content servers 120 and generate contextualized advertisement 320, 410 that is a channel-specific, media-specific, and user-specific.

In some examples, the contextualized advertisement (e.g., contextualized advertisement 320, 410, 510A-D) can be presented on a display. For example, the contextualized advertisement can be placed adjacent to the grid 402 of selectable channel tiles 402A-L, in the background of GUI 400A, 400B, 500, or any applicable portion of the display that can attract viewer's attention.

In some implementations, the contextualized advertisement (e.g., contextualized advertisement 320, 410, 510A-D) can include a deep link that links to play the media content on the target channel. For example, when user 132 provides user input on the contextualized advertisement (e.g., by clicking, touching, pointing, or by any applicable gesture, etc.), a deep link that is included in the contextualized advertisement can direct to a page where the media content associated with the advertisement can be played.

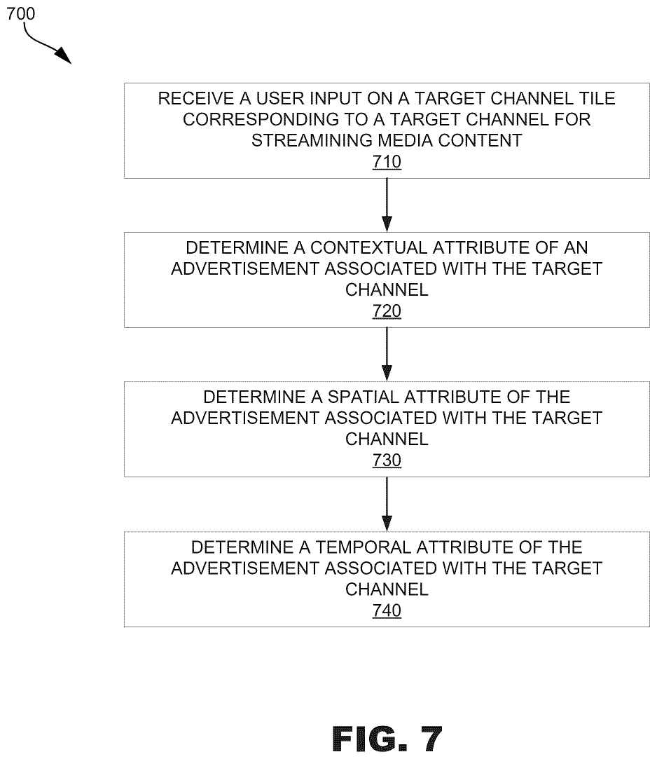

FIG. 7 illustrates a flowchart of an example method 700 for determining contextual, spatial, and temporal attributes of an advertisement for a target channel, according to some examples of the present disclosure. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art. Method 700 shall be described with reference to FIGS. 3 and 4A. However, method 700 is not limited to that example.

In step 710, method 700 includes receiving a user input on a target channel tile corresponding to a target channel for streaming media content. For example, AD management system 310 can receive a user input (e.g., from user 132) on target channel tile 402F corresponding to a target channel for streaming content 122.

In step 720, method 700 includes determining a contextual attribute of an advertisement associated with the target channel. For example, AD management system 310 may determine a context or contextual attribute of contextualized advertisement 320. The AD management system 310 can analyze content 122 and metadata 124 from content server 120 along with user data 302 and compute contextual attributes to generate contextualized advertisement 320.

The contextual attributes of the advertisement can include, for example and without limitation, a type or genre of an advertisement, a relevance to a viewer/audience, content alignment, cultural sensitivity, a background or surrounding environment of the advertisement, and so on. For example, if user data 302 indicates that user 132 has preferences of watching an action movie on Saturday night, AD management system 310 can identify an action movie that is available on the target channel and generate contextualized advertisement 320 that includes the action movie from the target channel.

In step 730, method 700 includes determining a spatial attribute of the advertisement associated with the target channel. For example, AD management system 310 may determine a spatial attribute (e.g., physical or geographic placement or size) of the contextualized advertisement 320. The AD management system 310 can determine placement or position within a display of a user device or viewer's device (e.g., GUI 400A, 400B, 500), a size of the contextualized advertisement 320, 410, scaling of visualization, and any other spatial aspects associated with the contextualized advertisement on a display. For example, the contextualized advertisement 320 can be displayed adjacent to the grid 402 of channel tiles 402A-L, as a background of GUI 400A, 400B, close to the target channel tile 402F, or any applicable portion of the display that can be eye-catching for user 132. In another example, the size of the contextualized advertisement 320, 410 can be adjusted based on user preferences or user profile.

In step 740, method 700 includes determining a temporal attribute of the advertisement associated with the target channel. For example, AD management system 310 may determine a temporal attribute of an advertisement associated with the target channel. The temporal attributes can include, for example and without limitation, the timing, frequency, duration or length, and any other temporal aspects associated with contextualized advertisement 320. For example, AD management system 310 can determine when to display contextualized advertisement 320 or when to stop displaying contextualized advertisement 320 (e.g., when user input is shifted to another channel tile, etc.). By way of example, AD management system 310 can analyze user's previous dwell time on the target channel or user conversion to the target channel to determine temporal attributes of the advertisement.

In some aspects, AD management system 310 may compute various dimensions of contextualized advertisement 320 (including the temporal, spatial, and contextual aspects) collectively and simultaneously to generate contextualized advertisement 320 that is content-specific, channel-specific, and/or user-specific. For example, a content provider (i.e., a channel) may display a different advertisement that promotes media content for different users such as media content A for user A and media content B for user B. In another example, an advertisement for the same media content on the same channel can include different images, actors, characters, conditions, or backgrounds for different users.

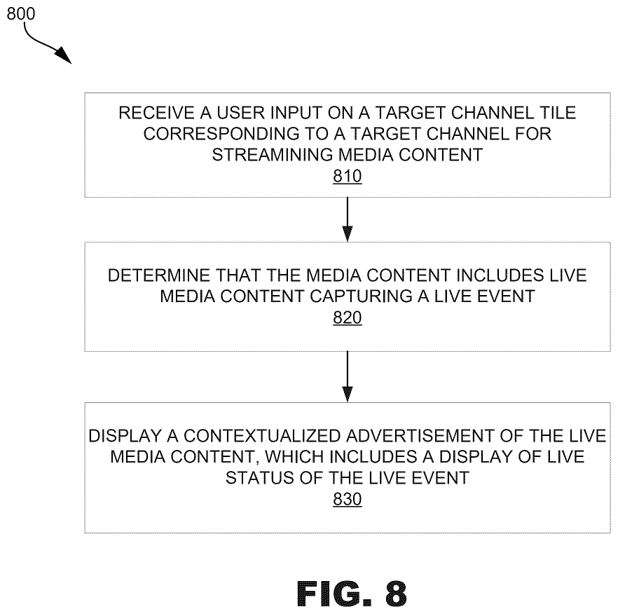

FIG. 8 illustrates a flowchart of an example method 800 for dynamically rendering a contextualized advertisement of a live media content, according to some examples of the present disclosure. Method 800 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art. Method 800 shall be described with reference to FIGS. 3 and 4A. However, method 800 is not limited to that example.

In step 810, method 800 includes receiving a user input on a target channel tile corresponding to a target channel for streaming media content. For example, AD management system 310 may receive a user input (e.g., from user 132) on target channel tile 402F corresponding to a target channel for streaming content 122.

In step 820, method 800 includes determining that the media content includes live media content capturing a live event. For example, AD management system 310 can determine that content 122 includes live media content, which captures a live event such as live television broadcasts, live streamlining on platforms, live radio broadcasts, live webinars, live social media broadcasts, and so on. The live media content can involve a wide range of genres and interests such as sports events (e.g., football, soccer, basketball, baseball, tennis, golf, etc.), live news broadcasts, live gaming/gameplay streams, music performances (e.g., concerts, performances, or studio sessions), press conferences, live streaming of stock exchange market or trading activities, live fitness classes, live cooking shows and food streams, live travel and nature streams, etc.

In some aspects, AD management system 310 can access content 122 and metadata 124, which may include information about the live event such as a type, theme, or genre of the live event, a geographic location or venue of the live event, a format or rules of the live event, participants in the live event (e.g., hosts, presenters, players, performers, guests, collaborators, etc.) and their profiles (e.g., demographics, statistics, sponsorships, etc.), on-going or real-time progress of the live event, a current mood and/or sentiment, a time and/or date, weather, and/or any other characteristics associated with the live event.

Further, AD management system 310 can access user profile (e.g., user data 302), which may include, for example and without limitation, user demographics (e.g., age, sex, geographic location, income, generation, occupation, etc.), user preferences (e.g., following teams or players, etc.), geographic location, privacy settings, viewing history or viewing patterns, social media activities, and so on.

In step 830, method 800 includes displaying a contextualized advertisement of the live media content, which includes a display of live status of the live event. For example, AD management system 310 may generate a contextualized advertisement 320 that promotes streaming of the live event based on content 122 and/or metadata 124 from content server 120 and user data 302. The contextualized advertisement 320 for the live event can include real-time game score or current status of the live event, an image of highlights of the live event, features of the user's following teams or players, and so on.

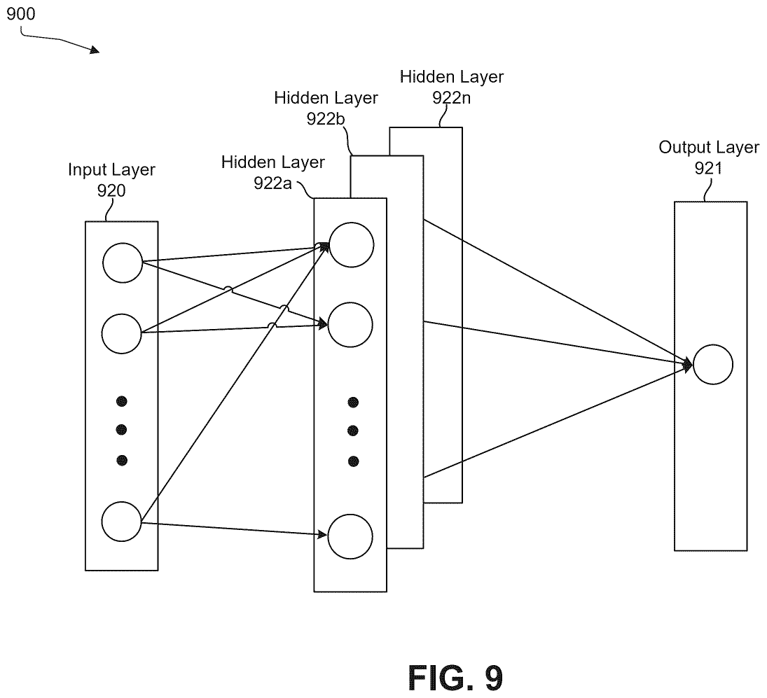

FIG. 9 is a diagram illustrating an example of a neural network architecture 900 that can be used to implement some or all of the neural networks described herein (e.g., ML model 312). The neural network architecture 900 can include an input layer 920 can be configured to receive and process data to generate one or more outputs. The neural network architecture 900 also includes hidden layers 922a, 922b, through 922n. The hidden layers 922a, 922b, through 922n include “n” number of hidden layers, where “n” is an integer greater than or equal to one. The number of hidden layers can be made to include as many layers as needed for the given application. The neural network architecture 900 further includes an output layer 921 that provides an output resulting from the processing performed by the hidden layers 922a, 922b, through 922n.

The neural network architecture 900 is a multi-layer neural network of interconnected nodes. Each node can represent a piece of information. Information associated with the nodes is shared among the different layers and each layer retains information as information is processed. In some cases, the neural network architecture 900 can include a feed-forward network, in which case there are no feedback connections where outputs of the network are fed back into itself. In some cases, the neural network architecture 900 can include a recurrent neural network, which can have loops that allow information to be carried across nodes while reading in input.

Information can be exchanged between nodes through node-to-node interconnections between the various layers. Nodes of the input layer 920 can activate a set of nodes in the first hidden layer 922a. For example, as shown, each of the input nodes of the input layer 920 is connected to each of the nodes of the first hidden layer 922a. The nodes of the first hidden layer 922a can transform the information of each input node by applying activation functions to the input node information. The information derived from the transformation can then be passed to and can activate the nodes of the next hidden layer 922b, which can perform their own designated functions. Example functions include convolutional, up-sampling, data transformation, and/or any other suitable functions. The output of the hidden layer 922b can then activate nodes of the next hidden layer, and so on. The output of the last hidden layer 922n can activate one or more nodes of the output layer 921, at which an output is provided. In some cases, while nodes in the neural network architecture 900 are shown as having multiple output lines, a node can have a single output and all lines shown as being output from a node represent the same output value.

In some cases, each node or interconnection between nodes can have a weight that is a set of parameters derived from the training of the neural network architecture 900. Once the neural network architecture 900 is trained, it can be referred to as a trained neural network, which can be used to generate one or more outputs. For example, an interconnection between nodes can represent a piece of information learned about the interconnected nodes. The interconnection can have a tunable numeric weight that can be tuned (e.g., based on a training dataset), allowing the neural network architecture 900 to be adaptive to inputs and able to learn as more and more data is processed.

The neural network architecture 900 is pre-trained to process the features from the data in the input layer 920 using the different hidden layers 922a, 922b, through 922n in order to provide the output through the output layer 921.

In some cases, the neural network architecture 900 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network architecture 900 is trained well enough so that the weights of the layers are accurately tuned.

To perform training, a loss function can be used to analyze an error in the output. Any suitable loss function definition can be used, such as a Cross-Entropy loss. Another example of a loss function includes the mean squared error (MSE), defined as E_total=Σ(½ (target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network architecture 900 can perform a backward pass by determining which inputs (weights) most contributed to the loss of the network, and can adjust the weights so that the loss decreases and is eventually minimized.

The neural network architecture 900 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network architecture 900 can include any other deep network other than a CNN, such as an autoencoder, Deep Belief Nets (DBNs), Recurrent Neural Networks (RNNs), among others.

As understood by those of skill in the art, machine-learning based techniques can vary depending on the desired implementation. For example, machine-learning schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

### Example Computer System

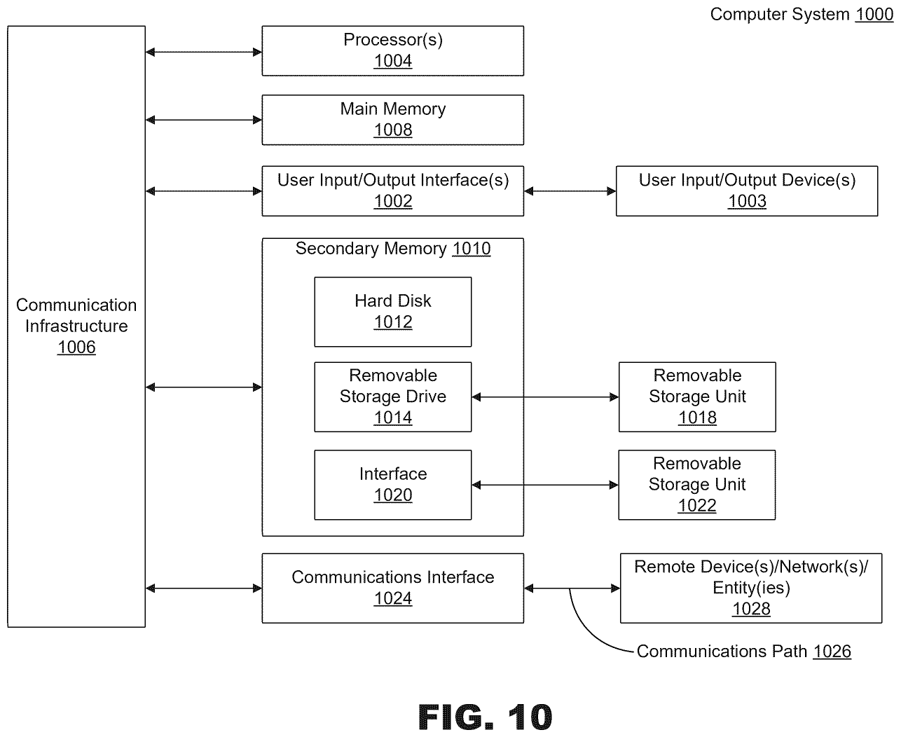

Various aspects and examples may be implemented, for example, using one or more well-known computer systems, such as computer system 1000 shown in FIG. 10. For example, the media device 106 may be implemented using combinations or sub-combinations of computer system 1000. Also or alternatively, one or more computer systems 1000 may be used, for example, to implement any of the aspects and examples discussed herein, as well as combinations and sub-combinations thereof.

Computer system 1000 may include one or more processors (also called central processing units, or CPUs), such as a processor 1004. Processor 1004 may be connected to a communication infrastructure or bus 1006.

Computer system 1000 may also include user input/output device(s) 1003, such as monitors, keyboards, pointing devices, etc., which may communicate with communication infrastructure 1006 through user input/output interface(s) 1002.

One or more of processors 1004 may be a graphics processing unit (GPU). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1000 may also include a main or primary memory 1008, such as random access memory (RAM). Main memory 1008 may include one or more levels of cache. Main memory 1008 may have stored therein control logic (e.g., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 may include a computer usable or readable storage device having stored thereon computer software (control logic) and/or data. Removable storage unit 1018 may be a floppy disk, magnetic tape, compact disk, DVD, optical storage disk, and/any other computer data storage device. Removable storage drive 1014 may read from and/or write to removable storage unit 1018.

Secondary memory 1010 may include other means, devices, components, instrumentalities or other approaches for allowing computer programs and/or other instructions and/or data to be accessed by computer system 1000. Such means, devices, components, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1000 may include a communication or network interface 1024. Communication interface 1024 may enable computer system 1000 to communicate and interact with any combination of external devices, external networks, external entities, etc. (individually and collectively referenced by reference number 1028). For example, communication interface 1024 may allow computer system xx00 to communicate with external or remote devices 1028 over communications path 1026, which may be wired and/or wireless (or a combination thereof), and which may include any combination of LANs, WANs, the Internet, etc. Control logic and/or data may be transmitted to and from computer system 1000 via communications path 1026.

Computer system 1000 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1000 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1000 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some examples, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000 or processor(s) 1004), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 10. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still cooperate or interact with each other.

The breadth and scope of this disclosure should not be limited by any of the above-described exemplary embodiments, but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: one or more memories; and at least one processor coupled to at least one of the one or more memories and configured to perform operations comprising: displaying a collection of selectable channel tiles on a first portion of a display, wherein each selectable channel tile represents a channel for streaming media content; receiving a user input on a target channel tile among the collection of selectable channel tiles, the target channel tile corresponding to a target channel; accessing a user profile that is associated with the user input; and generating, based on at least one of the user profile or one or more attributes associated with the target channel, a contextualized advertisement of one or more media content items provided by the target channel.

Aspect 2. The system of Aspect 1, wherein the contextualized advertisement is generated using a machine learning model.

Aspect 3. The system of any of Aspects 1 to 2, wherein the at least one processor is configured to perform operations comprising: presenting the contextualized advertisement on a second portion of the display, wherein the second portion of the display is adjacent to the first portion of the display.

Aspect 4. The system of any of Aspects 1 to 3, wherein the at least one processor is configured to perform operations comprising: generating the contextualized advertisement in a size of the target channel tile to be overlaid on a display region corresponding with the target channel tile.

Aspect 5. The system of any of Aspects 1 to 4, wherein the contextualized advertisement comprises a list of one or more advertisements for recommended media contents provided by the target channel.

Aspect 6. The system of any of Aspects 1 to 5, wherein the contextualized advertisement comprises a deep link that links to play the one or more media content items within the target channel.

Aspect 7. The system of any of Aspects 1 to 6, wherein the one or more media content items comprise live media content capturing a live event, and at least a portion of the contextualized advertisement presents a status of the live event.

Aspect 8. The system of any of Aspects 1 to 7, wherein the user profile includes at least one of user preferences, viewing history, demographics, user engagement with the target channel, or social media data.

Aspect 9. The system of any of Aspects 1 to 8, wherein the one or more attributes associated with the target channel include at least one of subscription options, a plurality of media contents that are available for streaming on the target channel, popularity of the plurality of media contents, or feedback from views on the plurality of media contents.

Aspect 10. The system of any of Aspects 1 to 9, wherein the one or more attributes associated with the target channel include a media content studio that produces or distributes the one or more media content items that are provided by the target channel.

Aspect 11. A method comprising: displaying a collection of selectable channel tiles on a first portion of a display, wherein each selectable channel tile represents a channel for streaming media content; receiving a user input on a target channel tile among the collection of selectable channel tiles, the target channel tile corresponding to a target channel; accessing a user profile that is associated with the user input; and generating, based on at least one of the user profile or one or more attributes associated with the target channel, a contextualized advertisement of one or more media content items provided by the target channel.

Aspect 12. The method of Aspect 11, wherein the contextualized advertisement is generated using a machine learning model.

Aspect 13. The method of any of Aspects 11 to 12, further comprising: presenting the contextualized advertisement on a second portion of the display, wherein the second portion of the display is adjacent to the first portion of the display.

Aspect 14. The method of any of Aspects 11 to 13, further comprising: generating the contextualized advertisement in a size of the target channel tile to be overlaid on a display region corresponding with the target channel tile.

Aspect 15. The method of any of Aspects 11 to 14, wherein the contextualized advertisement comprises a list of one or more advertisements for recommended media contents provided by the target channel.

Aspect 16. The method of any of Aspects 11 to 15, wherein the contextualized advertisement comprises a deep link that links to play the one or more media content items within the target channel.

Aspect 17. The method of any of Aspects 11 to 16, wherein the one or more media content items comprise live media content capturing a live event, and at least a portion of the contextualized advertisement presents a status of the live event.

Aspect 18. The method of any of Aspects 11 to 17, wherein the user profile includes at least one of user preferences, viewing history, demographics, user engagement with the target channel, or social media data.

Aspect 19. The method of any of Aspects 11 to 18, wherein the one or more attributes associated with the target channel include at least one of subscription options, a plurality of media contents that are available for streaming on the target channel, popularity of the plurality of media contents, or feedback from views on the plurality of media contents.

Aspect 20. A non-transitory computer-readable medium having instructions stored thereon that, when executed by at least one computing device, cause the one or more processors to perform a method according to any of Aspects 11 to 19.

Aspect 21. A system comprising means for performing a method according to any of Aspects 11 to 19.

Aspect 22. A computer program product having stored thereon instructions which, when executed by one or more processors, cause the one or more processors to perform a method according to any of Aspects 11 to 19.

What is claimed is:

1. A system comprising:
one or more memories; and
at least one processor coupled to at least one of the one or more memories and configured to perform operations comprising:
displaying a collection of selectable channel tiles on a first portion of a display, wherein each selectable channel tile represents a channel for streaming media content;
receiving a user input on a target channel tile among the collection of selectable channel tiles, the target channel tile corresponding to a target channel;
accessing a user profile that is associated with the user input; and
generating, based on at least one of the user profile or one or more attributes associated with the target channel, a contextualized advertisement of one or more media content items provided by the target channel.

2. The system of claim 1, wherein the contextualized advertisement is generated using a machine learning model.

3. The system of claim 1, wherein the at least one processor is configured to perform operations comprising:
presenting the contextualized advertisement on a second portion of the display, wherein the second portion of the display is adjacent to the first portion of the display.

4. The system of claim 1, wherein the at least one processor is configured to perform operations comprising:
generating the contextualized advertisement in a size of the target channel tile to be overlaid on a display region corresponding with the target channel tile.

5. The system of claim 1, wherein the contextualized advertisement comprises a list of one or more advertisements for recommended media contents provided by the target channel.

6. The system of claim 1, wherein the contextualized advertisement comprises a deep link that links to play the one or more media content items within the target channel.

7. The system of claim 1, wherein the one or more media content items comprise live media content capturing a live event, and at least a portion of the contextualized advertisement presents a status of the live event.

8. The system of claim 1, wherein the user profile includes at least one of user preferences, viewing history, demographics, user engagement with the target channel, or social media data.

9. The system of claim 1, wherein the one or more attributes associated with the target channel include at least one of subscription options, a plurality of media contents that are available for streaming on the target channel, popularity of the plurality of media contents, or feedback from views on the plurality of media contents.

10. The system of claim 1, wherein the one or more attributes associated with the target channel include a media content studio that produces or distributes the one or more media content items that are provided by the target channel.

11. A method comprising:
displaying a collection of selectable channel tiles on a first portion of a display, wherein each selectable channel tile represents a channel for streaming media content;
receiving a user input on a target channel tile among the collection of selectable channel tiles, the target channel tile corresponding to a target channel;
accessing a user profile that is associated with the user input; and
generating, based on at least one of the user profile or one or more attributes associated with the target channel, a contextualized advertisement of one or more media content items provided by the target channel.

12. The method of claim 11, wherein the contextualized advertisement is generated using a machine learning model.

13. The method of claim 11, further comprising:
presenting the contextualized advertisement on a second portion of the display, wherein the second portion of the display is adjacent to the first portion of the display.

14. The method of claim 11, further comprising:
generating the contextualized advertisement in a size of the target channel tile to be overlaid on a display region corresponding with the target channel tile.

15. The method of claim 11, wherein the contextualized advertisement comprises a list of one or more advertisements for recommended media contents provided by the target channel.

16. The method of claim 11, wherein the contextualized advertisement comprises a deep link that links to play the one or more media content items within the target channel.

17. The method of claim 11, wherein the one or more media content items comprise live media content capturing a live event, and at least a portion of the contextualized advertisement presents a status of the live event.

18. The method of claim 11, wherein the user profile includes at least one of user preferences, viewing history, demographics, user engagement with the target channel, or social media data.

19. The method of claim 11, wherein the one or more attributes associated with the target channel include at least one of subscription options, a plurality of media contents that are available for streaming on the target channel, popularity of the plurality of media contents, or feedback from views on the plurality of media contents.

20. A non-transitory computer-readable medium having instructions stored thereon that, when executed by at least one computing device, cause the at least one computing device to perform operations comprising:
displaying a collection of selectable channel tiles on a first portion of a display, wherein each selectable channel tile represents a channel for streaming media content;
receiving a user input on a target channel tile among the collection of selectable channel tiles, the target channel tile corresponding to a target channel;
accessing a user profile that is associated with the user input; and
generating, based on at least one of the user profile or one or more attributes associated with the target channel, a contextualized advertisement of one or more media content items provided by the target channel.
